(19) United States
(12) Patent Application Publication
(10) Pub. No.: US 2010/0265528 A1
(43) Pub. Date: Oct. 21, 2010

(54) Network print system, server computer used for the print system, recording medium recording program and recording medium recording printer driver

(75) Inventor: Shinichi Kawano, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/798,562

(22) Filed: Apr. 7, 2010

(30) Foreign Application Priority Data
Apr. 16, 2009 (JP) 2009-099698

(51) Int. Cl. G06F 3/12

(52) U.S. Cl. 358/1.13

(57) ABSTRACT

A server computer executes a program including: the step of receiving and storing install information, when a universal printer driver is installed in a client computer; the step of simultaneous broadcast transmission, to search for MFPs on a network; the step of storing MFP information based on responses to the simultaneous broadcast from the MFPs; and the step of storing, when a request for limiting use of MFPs is issued, information of MFPs of which use is limited. When the universal printer driver is activated in the client computer, printing is done by a usable MFP, in accordance with the information of MFPs of which use is limited, stored in the server.

### CROSS-REFERENCE TO RELATED APPLICATION

This nonprovisional application claims priority under 35 U.S.C. §119(a) on Patent Application No. 2009-099698 filed in Japan on Apr. 16, 2009, the entire contents of which are hereby incorporated by reference.

### BACKGROUND OF THE INVENTION

1. Field of the Invention

The present invention relates to a network print system in which a client computer, connected to a network together with a server computer and a plurality of printing apparatuses, prints an image using a printing apparatus. More specifically, the present invention relates to a technique of appropriately limiting use of printing apparatuses by a client computer, when a universal print driver is installed in the client computer.

2. Description of the Background Art

In a company or an office (hereinafter referred to as a “company”), generally, a computer (personal computer, hereinafter also simply referred to as a “PC”) is allocated to an individual, and good network environment including LAN (Local Area Network) and the Internet is provided. People routinely use electronic mails and the Internet.

Further, it is becoming more common place to share an image forming apparatus such as a printer in a company through LAN. A user operating a PC connected to LAN may have a word processor document or a spreadsheet document transmitted to an image forming apparatus through LAN and to have the document printed.

Typically, when electronic data in the form of a word processor document or a spreadsheet document created by a PC is to be printed by an image forming apparatus such as a printer, it is necessary that a printer driver supporting the printer must be installed beforehand in the PC that transmits the data, to have the electronic data transmitted in a format that can be converted to image data by the image forming apparatus.

The printer driver is a user interface allowing, when electronic data such as a word processor document or a spreadsheet document is transmitted to the image forming apparatus, the image forming apparatus to set print conditions, such as duplex printing, margin and the number of copies to be printed, for generating the image data.

After installing a printer driver, network settings, settings of mechanisms (options) of the printer and the like must be set (setting process) driver by driver.

In connection with usage management of network⁻connected printer, by way of example, the following techniques have been known.

Japanese Patent Laying-Open No. 2008-090834 (Document 1) discloses a method of remotely managing printer drivers. The method of managing printer settings includes the steps of; discovering physical printers in electronic communication with a network; discovering installed printers; associating physical printers with installed printers; specifying one or more default print settings; and updating the one or more default print settings of at least one of the installed printers, whereby printer settings can be managed, with one or more default settings specified from an installed printer.

According to the method of managing printer settings, physical printers in electronic communication with a network are discovered. The physical printers are associated with the installed printer drivers. One or more default print settings are specified, and one or more default print settings of at least one of the installed printers are updated. Then, the default settings of the printer driver are accessed remotely.

Japanese Patent Laying-Open No. 2007-304881 (Document 2) discloses a print system having an image forming apparatus and a terminal, in which by an operation on the image forming apparatus, print settings and print instruction made by the terminal can be effected. The print system includes: an image forming apparatus provided with display operating means and having a function of a printer client; and a terminal having a printer driver installed therein to have print data created by a data forming application and contents of print conditions settings related to the print data converted to data that can be interpreted by the image forming apparatus, and having a function of a printer server. The image forming apparatus has communication means connected to the terminal for receiving data related to contents of settings output from the printer driver. The printer driver includes storage means for storing data related to the contents of settings, and transmitting means for transmitting the data of contents of settings together with an application program including graphical user interface to the image forming apparatus. By the display operating means on the image forming apparatus, settings of print conditions and the instruction of print execution made by the terminal can be done.

By the print system, even when the image forming apparatus is placed away from the terminal that makes a print instruction, the print settings and the print instruction made by the terminal can be done on the image forming apparatus.

### SUMMARY OF THE INVENTION

Printer drivers that have been dominantly used are different specification by manufacturer and type of image forming apparatuses (in the following, also referred to as MFP: Multifunction Peripheral). Recently, however, a universal printer driver has been developed and comes to be practically used, to allow a plurality of different types of MFPs to print with one printer driver. The universal printer driver is usable for various printers, including various types of printers of its own manufacturer as well as printers made by other manufacturers. When such a universal printer driver is installed in a PC, it follows that any printers on the network can be used without restriction (without necessitating any special authorization).

In connection with the printer driver setting process described above, a method of automatically setting an MFP through automatic searching of a network at the time of installation has been known. If this method is applied to installation of a universal printer driver, all MFPs connected to the network and usable by the universal printer driver come to be registered. In such a situation, it may be possible for an administrator to limit use of a user or users in the manner as described in Document 1. The technique disclosed in Document 1, however, is for limiting use related to a printer driver for one type. Therefore, it is necessary to effectively limit use in relation to a driver that is applicable to a plurality of different types of printers, such as the universal printer driver.

The present invention was made to solve the above-described problem, and its object is to provide, when a universal printer driver is installed in a client computer to allow use of printing apparatuses on a network, a network print system, a server computer used for the print system, a recording medium recording a computer program and a recording medium recording the printer driver, for appropriately managing printing apparatuses on the network usable by the client computer.

According to a first aspect, the present invention provides a network print system in which a client computer, connected to a network together with a server computer and a plurality of printing apparatuses, prints an image using the printing apparatus. In response to installment of a universal printer driver independent of manufacturer and type of the printing apparatuses, the client computer transmits install information to the server computer. Based on the received install information, the server computer sets a printing apparatus or apparatuses usable by the client computer, among the printing apparatuses on the network.

According to a second aspect, the present invention provides a server computer used in a network print system in which a client computer, connected to a network together with the server computer and a plurality of printing apparatuses, prints an image using the printing apparatus. In response to installment of a universal printer driver independent of manufacturer and type of the printing apparatuses, the client computer transmits install information to the server computer. The server computer includes: a detecting unit detecting the plurality of printing apparatuses;

and a setting unit setting, based on the received install information, a printing apparatus or apparatuses usable by the client computer, among the printing apparatuses on the network.

By the network print system or the server computer used in the system as described above, the problem that any printing apparatus on the network can be used without any restriction when a universal printer driver is installed, can be avoided. Specifically, assume that a universal printer driver is installed in a client computer. Then, the server computer stores which of the client computers connected to the network have the universal printer installed therein. For the client computer thus stored, printing apparatuses that can be used among the plurality of printing apparatuses on the network are set. Therefore, even when a universal printer driver, which has a function of allowing use of printing apparatuses of different manufactures or different types by one driver, is installed in a client computer, printing apparatuses on the network that can be used by the client computer are limited by the server computer. Therefore, the client computer can only select from the usable printing apparatuses on the network. Therefore, even when a universal printer driver is installed, image data can be printed appropriately with the printing apparatuses on the network limited. As a result, printing apparatuses on the network that can be used by the client computer having a universal printer driver installed therein can be managed appropriately.

Here, the detecting unit may be adapted to detect the plurality of printing apparatuses by automatically searching through the network for the printing apparatuses connected to the network.

It is possible for the server computer to automatically search for the printing apparatuses connected to the network utilizing, for example, a simultaneous broadcasting function. Therefore, it is unnecessary for an administrator of the server computer to manually input the printing apparatuses on the network.

Further, the server computer may store the detected printing apparatus with an IP address, host name, printing speed and color/black-and-white information.

Since functions of printing apparatuses are stored, it is possible for the client computer to select, based on the functions, an optimal printing apparatus among the printing apparatuses of which use is permitted by the server computer.

Further, the setting unit may be adapted to set a printing apparatus or apparatuses usable either by the client computer or a user logged in to the client computer.

In the server-client network system, a plurality of users authorized by the server may log-in to and operate a client computer. Even in such a situation, use of printing apparatuses can be limited based not only on the client computer but also on the logged-in user.

Further, the setting unit may be adapted to set a printing apparatus to be used at the time of printing after the universal printer driver is installed in the client computer.

Transmission of wasteful information can be avoided until printing is actually done, after the user installed the printer driver. Further, the printing apparatus to be used may be set (limiting information may be set) when the power of client computer is turned on after installation or when the client computer is connected to the network, rather than at the time of printing.

A computer program recorded on a recording medium according to a third aspect of the present invention causes, when executed by a computer including a communication unit, a storage unit and an operating unit, the computer to function as any of the above-described server computers.

A printer driver recorded on the recording medium according to a fourth aspect of the present invention is a universal printer driver independent of manufacturer and type of printing apparatuses. When the driver is installed in a computer including a communication unit, a storage unit and an operating unit, in the computer, the universal printer driver is stored in the storage unit to enable execution of a print request processing, install information is transmitted to the server computer, and based on the information received from the server computer, image data is transmitted to a printing apparatus of which use is permitted.

Further, the computer may additionally include a display unit, and when the printer driver is installed in the computer, based on the information received from the server computer, a printing apparatus or apparatuses of which use is permitted may be displayed on the display unit.

Further, when the printer driver is installed in the computer, based on the information received from the server computer, only a printing apparatus or apparatuses of which use is permitted may be displayed on the display unit.

With such a printer driver, it becomes possible in a client computer having the printer driver installed therein to appropriately use the usable printing apparatuses on the network.

According to the present invention, even if a universal printer driver, which has a function of enabling, with a single driver, use of various printing apparatuses of different types or manufactured by different manufacturers, is installed in a client computer, the server computer limits the printing apparatuses on the network usable by the client computer. Therefore, the client computer can only select from the usable printing apparatuses on the network. As a result, even if a universal printer driver is installed, it is possible to have image data printed appropriately while limiting the printing apparatuses on the network. Thus, it is possible to appropriately manage printing apparatuses on the network that can be used by the client computer having a universal printer driver installed therein.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an overall configuration of a network print system in accordance with an embodiment of the present invention.

FIG. 2 is a control block diagram showing hardware configuration of a client computer (PC) shown in FIG. 1.

FIG. 3 is a control block diagram showing hardware configuration of a server computer shown in FIG. 1.

FIG. 4 is a control block diagram showing hardware configuration of an MFP shown in FIG. 1.

FIG. 5 is a flowchart representing control structures of a use limiting program executed by the client computer, server computer and MFP of FIG. 1, respectively.

FIG. 6 is a flowchart representing control structures of a printing program executed by the client computer, server computer and MFP of FIG. 1, respectively.

FIG. 7 shows transitions related to the operation when the program shown in FIG. 5 is executed.

FIG. 8 shows transitions related to the operation when the program shown in FIG. 6 is executed.

FIG. 9 shows an MFP limiting database stored in the server computer.

FIG. 10 shows MFP information stored in the server computer.

FIG. 11 shows an exemplary image for setting use limitations displayed on the server computer.

FIG. 12 shows another exemplary image for setting use limitations displayed on the server computer.

FIG. 13 shows an exemplary image for setting use limitations displayed on the client server.

### DESCRIPTION OF THE PREFERRED EMBODIMENTS

In the following description, the same components are denoted by the same reference characters. Their names and functions are also the same. Therefore, detailed description thereof will not be repeated. In the following, the image forming apparatus (typically, a printing apparatus) that receives a print request from a client computer (PC) and forming an image on a paper medium is an MFP. The present invention, however, is not limited to an MFP, and the invention is applicable to any device having at least the printing function.

[Overall System Configuration]

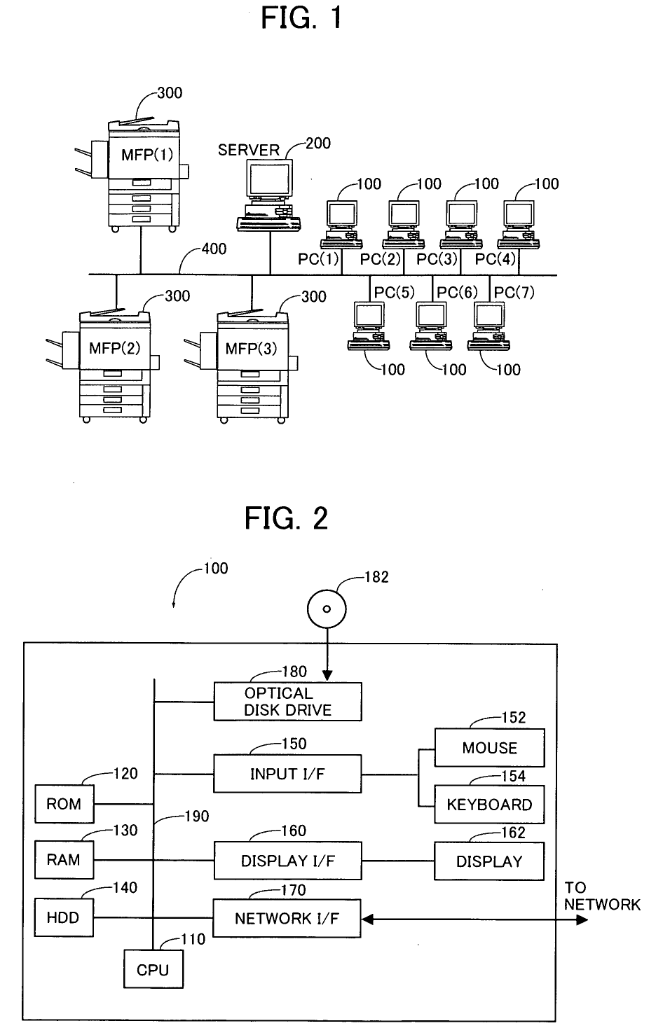

Referring to FIG. 1, an overall configuration of the network print system in accordance with an embodiment of the present invention will be described. The network print system includes: client computers 100 (personal computers PC(1) to PC(7)), MFPs 300 (MFP(1) to MFP(3)) receiving a print request and forming an image on a paper medium; and a server computer 200 managing use limitations of MFPs 300 from client computers 100. Client computers 100, server computer 200 and MFPs 300 are connected to be communicable by a network line 400 in compliance with, for example, IEEE 802.3.

In the following description and in the drawings, client computer 100 may also be simply referred to as a client, and server computer 200 may also be simply referred to as a server.

[Hardware Configuration]

<Client Computer 100>

Referring to FIG. 2, client computer 100 forming the network print system in accordance with the present embodiment includes: a bus 190; a CPU (Central Processing Unit) 110 connected to bus 190; an ROM (Read Only Memory) 120 connected to bus 190; an RAM (Random Access Memory) 130 connected to bus 190; a hard disk (HDD) 140 connected to bus 190; an optical disk drive 180 connected to bus 190, to which an optical disk 182 can be mounted, capable of writing information to and reading information from optical disk 182; an input interface (hereinafter referred to as “input I/F”) 150 connected to bus 190, providing an interface for connection to a mouse 152 and a keyboard 154; a display interface (hereinafter referred to as “display I/F”) 160, connected to bus 190, providing an interface for connection to a display 162; and a network interface (hereinafter referred to as “network I/F”) 170 providing wired or wireless (in the present embodiment, wired) connection to network line 400. Client computer 100 may include a magnetic disk drive, to which a magnetic disk can be mounted, capable of writing information to and reading information from the magnetic disk, in place of/in addition to optical disk drive 180.

Bus 190, ROM 120, RAM 130, hard disk 140, optical disk drive 180, input I/F 150, display I/F 160 and network I/F 170 cooperate with each other under the control of CPU 110, and realizes processes of various applications in client computer 100. These applications include, for example, the processes for producing word processor documents, spreadsheet documents, and printing process for transmitting the electronic data produced by these processes to MFP 300.

A computer program causing client computer 100 to execute the processes mentioned above is stored in optical disk 182 inserted to optical disk drive 180, and transferred to hard disk 140. Alternatively, the program may be transmitted through network line 400 to client computer 100 and stored in hard disk 140. The program is loaded to RAM 130 at the time of execution. The program may directly be loaded to RAM 130 from optical disk 182 or through network line 400.

Such a program includes a plurality of instructions to cause client computer 100 to execute prescribed processes. Some of the basic functions necessary to realize such operations are provided by the operating system (OS) operating on client computer 100 or third party programs, or modules of various tool kits installed in client computer 100. Therefore, the program may not necessarily include all functions required for realizing the system in accordance with the present embodiment. The program may simply include an instruction to execute the prescribed processes of client computer 100 as described above by calling appropriate functions or “tools” in a controlled manner to attain desired results. General operations of a computer acting as client computer 100 are well known and, therefore, description thereof will not be given here.

<Server Computer 200>

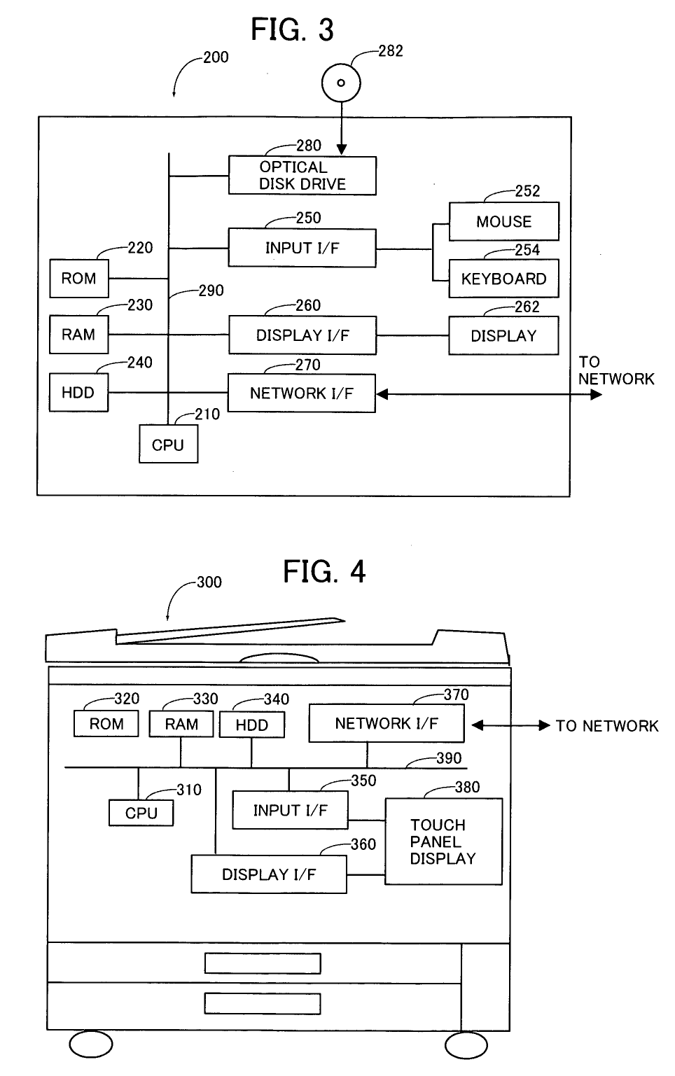

Referring to FIG. 3, server computer 200 forming the network print system in accordance with the present embodiment is a computer having a similar configuration as client computer 100 described above. Parts of higher reliability are used for components of a server computer than those for components of a PC used as a client computer.

Server computer 200 includes: a bus 290; a CPU 210 connected to bus 290; an ROM 220 connected to bus 290; an RAM 230 connected to bus 290; an HDD 240 connected to bus 290; an optical disk drive 280 connected to bus 290, to which an optical disk 282 can be mounted, capable of writing information to and reading information from optical disk 282; an input I/F 250 connected to bus 290, providing an interface for connection to a mouse 252 and a keyboard 254; a display I/F 260, connected to bus 290, providing an interface for connection to a display 262; and a network I/F 270 providing wired or wireless (in the present embodiment, wired) connection to network line 400. As in the case of client computer 100, server computer 200 may include a magnetic disk drive, in place of/in addition to optical disk drive 280.

Bus 290, ROM 220, RAM 230, hard disk 240, optical disk drive 280, input I/F 250, display I/F 260 and network I/F 270 cooperate with each other under the control of CPU 210, and server computer 200 as the server computer in accordance with the present embodiment realizes processes of various applications. These applications realize, when a universal printer driver is installed, for example, in client computer 100 to enable use of a plurality of MFPs 300, a server computer in a network print system that appropriately manages MFPs usable by client computer 100.

A computer program causing server computer 200 to execute the operations of the server computer in the network print system in accordance with the present embodiment is stored in optical disk 282 inserted to optical disk drive 280, and transferred to hard disk 240. Alternatively, the program may be transmitted through network line 400 to server computer 200 and stored in hard disk 240. The program is loaded to RAM 230 at the time of execution. The program may directly be loaded to RAM 230 from optical disk 282 or through network line 400.

Such a program includes a plurality of instructions to cause server computer 200 to execute the operations of the server computer in the network print system in accordance with the present embodiment. Some of the basic functions necessary to realize such operations are provided by the operating system (OS) operating on server computer 200 or third party programs, or modules of various tool kits installed in server computer 200. Therefore, the program may not necessarily include all functions required for realizing the system in accordance with the present embodiment. The program may simply include an instruction to execute the prescribed processes of server computer 200 as described above by calling appropriate functions or “tools” in a controlled manner to attain desired results. General operations of a computer acting as server computer 200 are well known and, therefore, description thereof will not be given here.

<MFP 300>

Referring to FIG. 4, MFP 300 forming the network print system in accordance with the present embodiment includes: a bus 390; a CPU 310 connected to bus 390; an ROM 320 connected to bus 390; an RAM 330 connected to bus 390; an HDD 340 connected to bus 390; an input I/F 350 and a display I/F 360 connected to bus 390, providing an interface for connection to a touch panel display 380; and a network I/F 370, connected to bus 390, providing wired or wireless (in the present embodiment, wired) connection to network line 400.

Bus 390, ROM 320, RAM 330, hard disk 340, input I/F 350, display I/F 360 and network I/F 370 cooperate with each other under the control of CPU 310, and in MFP 300, realize printing process, facsimile transmitting/receiving process, scanning process and copying process. These processes are executed by various parts forming MFP 300, not shown in FIG. 4, under the control of CPU 310.

By way of example, MFP 300 includes a document reading unit, an image forming unit, a paper feed unit and a paper discharging device. In MFP 300, image data received from client computer 100 is processed variously by CPU 310, and the resulting image data is output to the image forming unit. MFP 300 has a so-called laser type printer function, in which a laser beam is utilized for exposure. It may have a different type printer function.

The image forming unit is for printing an image represented by the image data on a sheet of recording paper, and it includes, by way of example, a photoreceptor drum, a charger, a laser scanning unit, a developer, a transfer device, a cleaning device, a fixing device and a neutralizer. In the image forming unit, a feeding path, for example, is formed, and a sheet of recording paper fed from the paper feed unit is fed along the feeding path. The paper feed unit draws out sheets of recording paper stacked on a paper feed cassette or on a manual feed tray one by one, and feeds the sheet of paper to the feeding path of the image forming unit.

While the sheet of recording paper is fed along the feeding path of image forming unit, the sheet passes between the photoreceptor drum and the transfer device, and further passes through the fixing device, whereby printing is done on the sheet of recording paper.

The photoreceptor drum rotates in one direction, and its surface is cleaned by the cleaning device and the neutralizer and, thereafter, uniformly charged by the charger. The laser scanning unit modulates the laser beam based on the image data to be printed, and repeatedly scans the surface of photoreceptor drum with the laser beam in a main scanning direction, whereby an electrostatic latent image is formed on the surface of photoreceptor drum. The developer develops the electrostatic latent image by supplying toner to the surface of photoreceptor drum, and thus, a toner image is formed on the surface of photoreceptor drum.

The transfer device transfers the toner image on the surface of photoreceptor drum to the sheet of recording paper passing between the transfer device and the photoreceptor drum. The fixing device includes a heating roller for heating the sheet of recording paper and the pressure roller for pressing the sheet of recording paper. As the sheet of recording paper is heated by the heating roller and pressed by the pressure roller, the toner image that has been transferred to the sheet of recording paper is fixed on the sheet. The sheet of recording paper discharged from the fixing device (printed paper) is discharged to the discharge tray. The paper discharging device may perform a process of sorting a plurality of printed sheets of paper to be output to different discharge trays, a process of punching each sheet of recording paper or a process of stapling the sheets of recording paper. Assume that a number of copies of the printing are to be prepared. In that case, sheets of recording paper are sorted and discharged to paper discharge trays such that each tray contains each set of printed sheets, and the set of printed sheets in each tray is stapled or punched, whereby copies of prints are prepared. Such processes are performed under the control of CPU 310.

[Software Configuration]

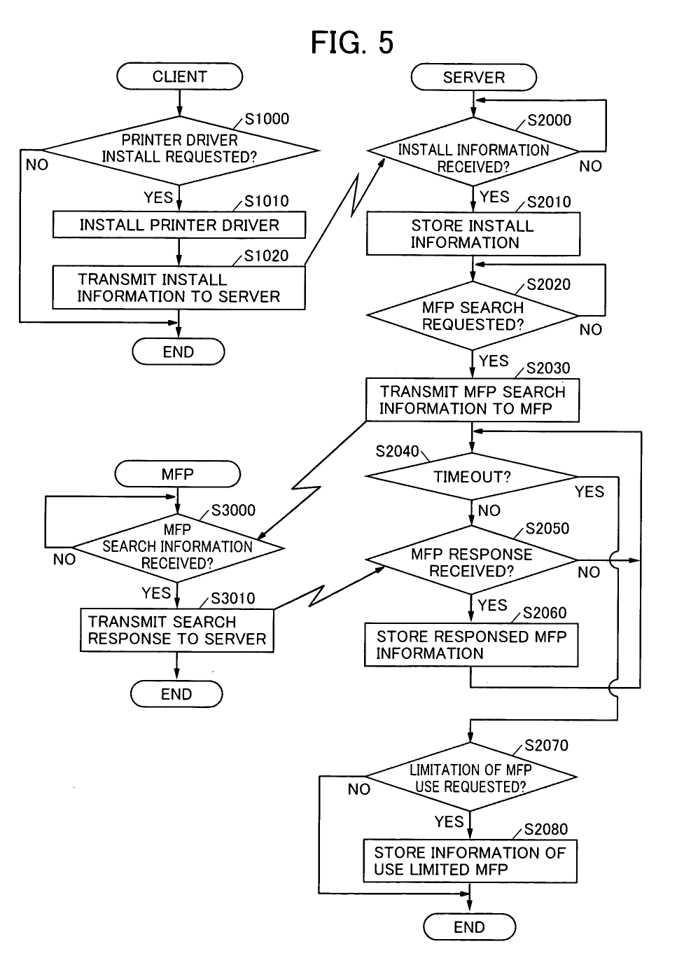

Referring to FIG. 5, the control structure of a computer program executed by client computer 100, server computer 200 and MFP 300 to realize the use limiting process of the network print system in accordance with the present embodiment will be described. The program executed by CPU 110 of client computer 100 includes a program executed by the installed printer driver (specifically, processes other than S1000 and S1010).

The program shown on the upper left side of FIG. 5 is executed by CPU 110 of client computer 100. At step (hereinafter, “step” will be denoted by “S”) 1000, CPU 110 determines whether or not a request for installing a printer driver (here, the printer driver is a universal printer driver) is detected. By way of example, if a user operating client computer 100 inserts an optical disk 182 storing a universal printer driver to optical disk drive 180 and issues an install instruction, or issues an instruction to download a universal printer driver from a prescribed site, using mouse 152 or keyboard 154, it is determined that the request for installing a universal printer driver is detected. If the request for installing the universal printer driver is detected (YES at S1000), the process proceeds to S1010. Otherwise (NO at S1000), the process ends.

At S1010, CPU 110 installs the universal printer driver. More specifically, CPU 110 stores the universal printer driver in HDD 140 to enable execution. The process of S1010 continues until install of the universal printer driver is completed.

At S1020, when install of the universal printer driver ends, CPU 110 transmits install information to server computer 200. Here, after completion of installation, CPU 110 generates client computer identification information including the information that the universal printer driver has been installed in client computer 100, IP address of client computer 100, host name and the like, and transmits the install information including such pieces of information through network I/F 170 and network line 400 to server computer 200. The process at S1020 corresponds to the process of S2000 of server computer 200, which will be described later. Thereafter, the process in client computer 100 ends.

The program shown on the right side of FIG. 5 is executed by CPU 210 of server computer 200. At S2000, CPU 210 determines whether or not the install information has been received from client computer 100 in which the universal printer driver is installed. Receiving the information that the universal printer driver has been installed (YES at S2000), the process proceeds to S2010. Otherwise (NO at S2000), the process returns to S2000, to wait until the install information is received from client computer 100.

At S2010, CPU 210 stores the install information in HDD 240. At S2020, CPU 210 determines whether or not a request for searching MFPs on the network has been detected. When an administrator of server computer 200 issues a broadcast request for transmitting simultaneous broadcast data to all of unidentified number of apparatuses connected to the computer network in order to search for the MFPs that can be used on the network, it is determined that the search for MFPs is requested. If the search for MFPs is requested (YES at S2020), the process proceeds to S2030. Otherwise (NO at S2020), the process returns to S2020 to wait until the administrator of server computer 200 requests searching of MFPs. It is also possible to once terminate the process if the determination at S2020 is NO.

At S2030, CPU 210 transmits broadcast request information (MFP searching information) for transmitting simultaneous broadcast data to all apparatuses on the network including MFP 300. The process at S2030 corresponds to the process at S3000 of MFP 300, which will be described later. Further, the process at S2030 may be automatically done by server computer 200 at a prescribed time interval. At S2040, CPU 210 determines whether or not a predetermined time has passed after simultaneous broadcast and timeout has reached. If timeout has reached (YES at S2040), the process proceeds to S2070. Otherwise (NO at S2040), the process proceeds to S2050.

At S2050, CPU 2010 determines whether or not a response from MFP 300 is received. If the response from MFP 300 is received (YES at S2050), the process proceeds to S2060. Otherwise (NO at S2050), the process returns to S2040.

At S2060, if a response is received from MFP 300, CPU 210 stores the MFP information in HDD 240. The MFP information includes product name, MFP's image, name (or IP address) and the like associated with the received MFP response. Thereafter, the process returns to S2040, to process response from MFP 300 until timeout is reached.

At S2070, CPU 210 determines whether or not a request for limiting MFP use is detected. For instance, when an administrator of server computer 200 sets an MFP or MFPs that can be used for printing for each client computer 100 and presses a registration button, it is determined that the request for limiting MFP use is detected. If it is determined that the request for limiting MFP use is detected (YES at S2070), the process proceeds to S2080. Otherwise (NO at S2070), the process in server computer 200 ends.

The program shown on the lower left side of FIG. 5 is executed by CPU 310 of MFP 300. At S3000, CPU 310 determines whether or not broadcast request information (MFP search information), requesting transmission of simultaneous broadcast data, is received from server computer 200. If the MFP search information is received (YES at S3000), the process proceeds to S3010. Otherwise (NO at S3000), the process returns to S3000, to wait until the MFP search information is received from server computer 200. It is also possible to once terminate the process if the determination at S3000 is NO.

At S3010, in response to reception of MFP search information, CPU 310 transmits the MFP information of itself to server computer 200. The process at S3010 corresponds to the process at S2050 by server computer 200 described above.

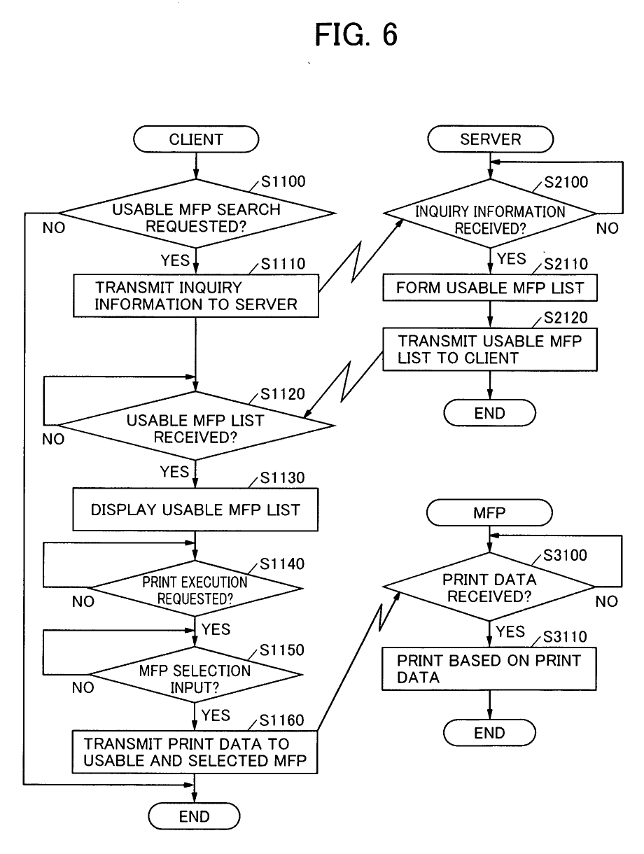

Referring to FIG. 6, control structure of computer programs executed by client computer 100, server computer 200 and MFP 300 in order to realize printing process in the network print system in accordance with the present embodiment will be described.

The program shown on the left side of FIG. 6 is executed by CPU 110 of client computer 100 having the universal printer driver installed therein. At S1100, CPU 110 determines whether or not a request for searching an MFP or MFPs that can be used by itself has been detected. Here, if the user of client computer 100 operates the universal printer driver (activates the universal printer driver), it is determined that search for the MFP or MFPs that can be used by itself is requested. If search for the MFP or MFPs that can be used by itself is requested (YES at S1100), the process proceeds to S1110. Otherwise (NO at S1100), the process in client computer 100 ends.

At S1110, CPU 110 transmits inquiry information of usable MFP to server computer 200. The process at S1110 corresponds to the process at S2100 of server computer 200, which will be described later.

At S1120, CPU 110 determines whether or not a list of usable MFPs is received from server computer 200. The MFP list is formed by server computer 200. If the list of usable MFPs is received (YES at S1120), the process proceeds to S1130. Otherwise (NO at S1120), the process returns to S1120, to wait until the list of usable MFPs is received from server computer 200.

At S1130, based on the list of usable MFPs received from server computer 200, CPU 110 displays MFPs that can be used by itself on a display 162.

At S1140, CPU 110 determines whether or not a print execution request has been detected. At this time, if a print execution button of universal printer driver displayed on display 162 is clicked by mouse 152, the print execution request is detected (YES at S1140). If the print execution request is detected (YES at S1140), the process proceeds to S1150. Otherwise (NO at S1140), the process returns to S1140, to wait until printing is requested by client computer 100. It is also possible to once terminate the process if the determination at S1140 is NO.

At S1150, CPU 110 determines whether or not an MFP selection is input. Here, on the universal printer driver displayed on display 162, icons representing a plurality of usable MFPs are displayed, and if one of the plurality of icons is clicked by mouse 152, input of an MFP selection is detected. As will be described later, it is assumed that two or more MFPs 300 are set to usable state, for one client computer 100. If the input of MFP selection is detected (YES at S1150), the process proceeds to S1160. Otherwise (NO at S1150), the process returns to S1150, to wait until an MFP selection is input, in client computer 100. If the determination at S1150 is NO after the lapse of a prescribed time period (after time-up of a delay timer), it is also possible to once terminal the process. At S1160, CPU 110 transmits the print data generated by the universal printer driver to MFP 300 that is usable by itself and selected. The process at S1160 corresponds to the process at S3100 of MFP 300, which will be described later.

The program shown on the upper right side of FIG. 6 is executed by CPU 210 of server computer 200. At S2100, CPU 210 determines whether or not an inquiry information (information inquiring MFPs usable by itself, from client computer 100) is received from client computer 100 in which the universal printer driver is installed. If the inquiry information is received (YES at S2100), the process proceeds to S2020. Otherwise (NO at S2100), the process returns to S2100, to wait until the inquiry information is received from client computer 100.

At S2110, CPU 210 forms an MFP list, indicating a list of MFPs 300 that can be used by client computer 100 that transmitted the inquiry information. At S2120, CPU 210 transmits the formed MFP list to the client computer 100 that transmitted the inquiry information. The process at S2120 corresponds to the process at S1120 of client computer 100 described above. Thereafter, the process in server computer 200 ends.

The program shown on the lower right side of FIG. 6 is executed by CPU 310 of MFP 300. At S3100, CPU 310 determines whether or not the print data is received from client computer 100. If the print data is received from client computer 100 (YES at S3100), the process proceeds to S3110. Otherwise (NO at S3100), the process returns to S3100, to wait until the print data is received from client computer 100.

At S3100, based on the received print data, CPU 310 prints an image corresponding to the print data on paper medium, using the image forming unit, paper feed unit and discharging device.

[Operation]

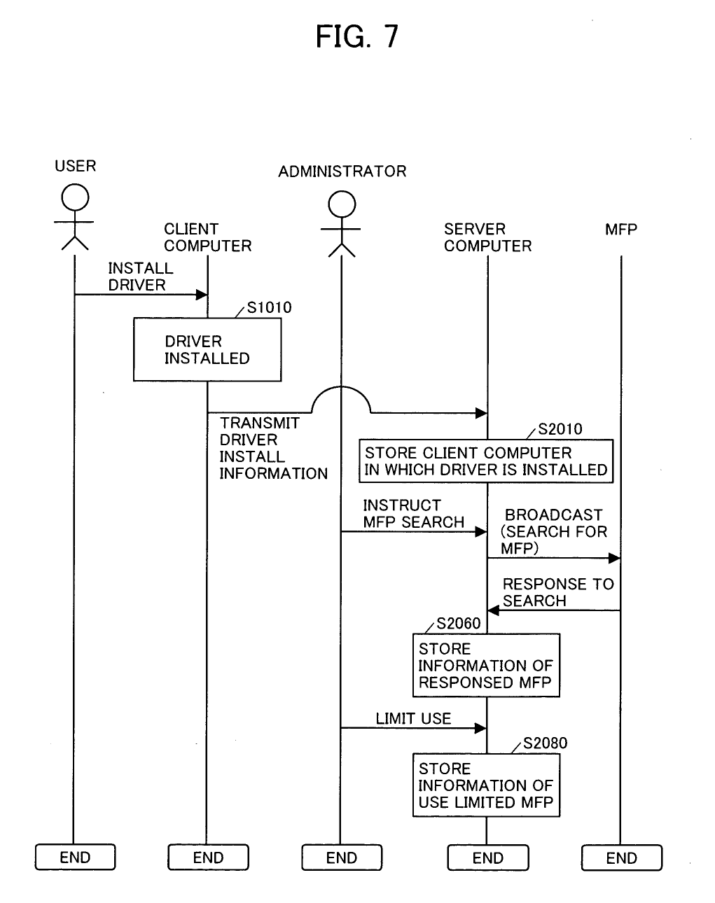

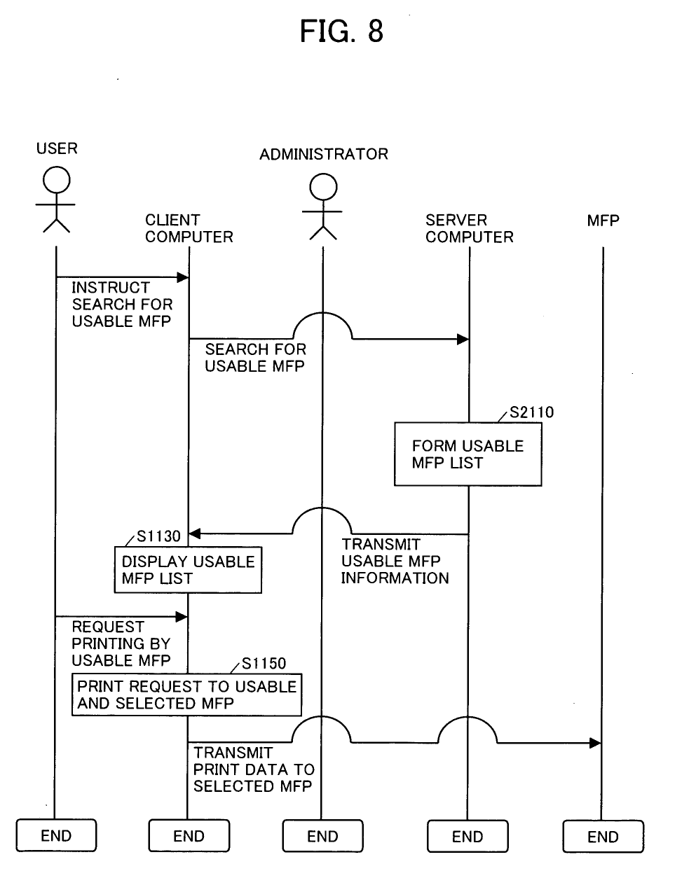

An operation of the network print system in accordance with the present embodiment based on the structure and the flowchart above will be described in the following. FIG. 7 shows transitions related to the operation when the use limiting program shown in FIG. 5 is executed, and FIG. 8 shows transitions related to the operation when the printing program shown in FIG. 6 is executed.

<Operation of Limiting Use>

Referring to the flowchart of FIG. 5 and the transition diagram of FIG. 7, the operation of limiting use in the network print system will be described.

First, the user of client computer 100 operates client computer 100 (for example, operates mouse 152 or keyboard 154), so that a universal printer driver necessary for printing by MFP 300 on the network is installed in HDD 140 of client computer 100 (YES at S1000, S1010).

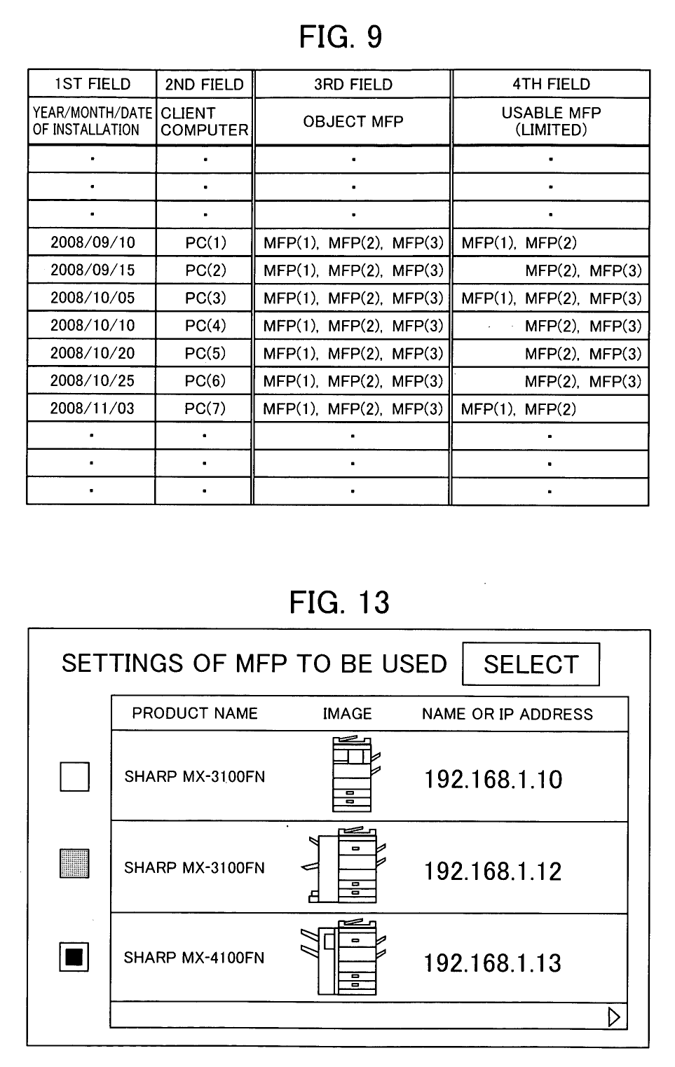

When installation of universal printer driver is completed, the install information (including the IP address of client computer 100, host name and the like) that the universal printer driver is installed in client computer 100 is transmitted to server computer 200 (S1020). Server computer 200 stores the received install information in HDD 240 of server computer 200 (S2010). The install information stored in HDD 240 of server computer 200 is, for example, as shown in FIG. 9, and has “year, month and date of installation” stored in the first field and “client computer name (host name)” stored in the second field. The IP address of client computer 100 may be stored.

When the administrator of server computer 200 searches for MFPs 300 usable on the network (YES at S2020), MFP search information requesting searching of MFP 300 is simultaneously broadcast (S2030). Receiving the MFP search information (YES at S3000), in response, MFP 300 transmits MFP information of itself to server computer 200 (S3010). Such response from MFP 300 to server computer 200 is waited for a prescribed time period.

After the timeout (YES at S2040), based on the response from MFPs 300 received by server computer 200, MFP information is stored in HDD 240 of server computer 200 (S2060). Here, as shown in FIG. 10, as the MFP information, product name, MFP's image (preferably MFP's image that can be used as an icon), name, IP address or the like of MFP 300 is stored as the MFP information, associated to each MFP 300. Further, MFPs that responsed the inquiry from server computer 200 are stored as object MFPs in the third field of install information shown in FIG. 9. Though not shown in FIG. 10, speed of printing, distinction of color/black-and-white and the like may be additionally stored in an associated manner.

Next, when the administrator of server computer 200 requests limit on the use of MFPs 300 for each client computer 100, for example, when the MFPs that can be used for printing by client computer 100 are set and the “registration” button is pressed (YES at S2070) on the setting image shown in FIG. 11 (image displayed on display 262 of server computer 200), server computer 200 stores the usable MFP information in HDD 240. At this time, in response to the request for limiting use from the administrator of server computer 200, usable MFPs (limited) are stored in the fourth field of install information shown in FIG. 9.

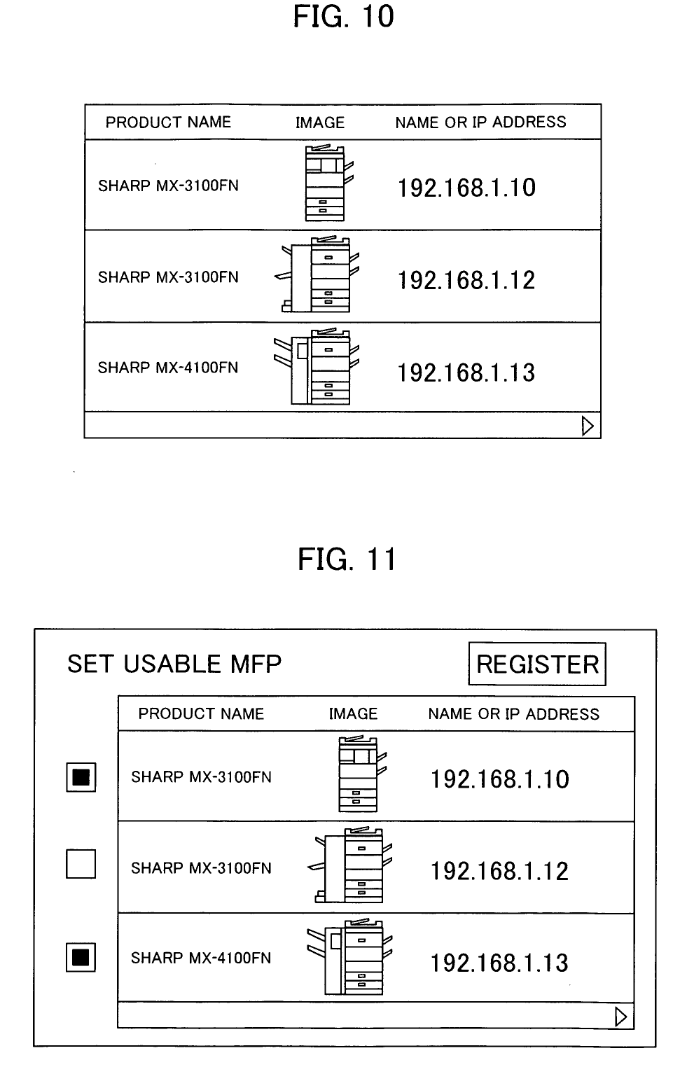

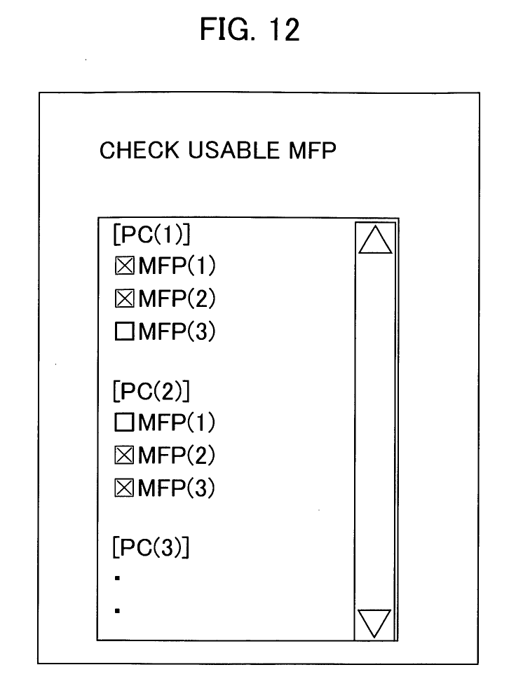

It is also possible to set limit of use of MFP 300 on the network for each client computer 100 on the network, using the setting image shown in FIG. 12 (image displayed on display 262 of server computer 200).

FIG. 12 shows an example of setting in which, for the client computer PC (1), use of MFP (1) and MFP (2) are permitted, use of MFP (3) is not permitted, and for client computer PC (2), use of MFP (2) and MFP (3) is permitted and use of MFP (1) is not permitted. With such setting, server computer 200 stores the data of use limitation of each MFP for each client computer 100, in HDD 240 (S2030).

<Print Operation>

Referring to the flowchart of FIG. 6 and the transition diagram of FIG. 8, the print operation of network print system will be described.

First, the user of client computer 100 operates client computer 100 to activate the installed universal printer driver, and inquires of server computer 200 about the MFPs 300 that it can use (YES at S1100, S1110). Receiving the inquiry information, server computer 200 forms the MFP list listing MFPs usable by client computer 100 that transmitted the inquiry (S2110). At this time, the management table shown in FIG. 9 stored in HDD 240 is looked up. The MFP list thus formed is transmitted to client computer 100 that transmitted the inquiry (S2120).

Receiving the MFP list transmitted from server computer 200 (YES at S1120), client computer 100 displays an image such as shown in FIG. 13 on display 162 of client computer 100 (S1130). The user of client computer 100 clicks a check box displayed on a side of MFP 300 to be used for printing, and clicks “SELECT” button with mouse 152 (YES at S1140, YES at S1150). Print data is transmitted from client computer 100 to the usable selected MFP 300, and the image is printed by the MFP 300 (S3110). In the example shown in FIG. 13, the MFP shown on the second box from the top (corresponding to MFP (2)) is unusable while MFPs shown on the first and third boxes (corresponding to MFP (1) and MFP (3)) are usable, and here, MFP shown on the third box (corresponding to MFP(3)) is selected. FIG. 13 corresponds to FIG. 11. Though an unusable MFP is also shown in FIG. 13, it is also possible to show only the usable MFPs. This conveniently allows the user to easily select the MFP he/she wants to use from the list of actually usable MFPs.

As described above, by the network print system in accordance with the present embodiment, even when a universal printer driver allowing use of printers of a plurality of different types of MFPs by only one printer driver is installed, the network printers that can be used by the client computer are limited by the server computer. Therefore, the client computer can only select the usable network printers. Therefore, even when a universal printer driver is installed, image data can appropriately be printed while the network printers are limited. In other words, it is possible to appropriately manage network printers that can be used by the client computer in which the universal printer driver is installed.

<First Modification>

In the embodiment described above, usable MFPs 300 are set for client computer 100. In addition to or in place of such an approach, usable MFPs 300 may be set in accordance with the logged-in user name.

If the usable MFPs 300 are to be set in accordance with the logged-in user name in place of setting usable MFPs 300 for each client computer 100, it is possible to manage usable MFPs for each user using the user management table for managing usable MFPs for each user prepared by changing the contents of the second field of management table shown in FIG. 9 from client computer to user name.

If the usable MFPs are to be set for client computer 100 and further in accordance with the logged-in user name, information of who logged in to which client computer 100 is transmitted from client computer 100 to server computer 200, and by combining the management table shown in FIG. 9 and the user management table described above, usable MFPs for each client computer 100 and each user can be managed.

<Second Modification>

Even at present, various types of universal printer drivers have been developed and presented for use. Therefore, server computer 200 obtains driver type information indicating the type of universal printer driver from client computer 100, and in accordance with the driver type information, the types of MFPs usable by the universal printer driver are obtained. From the types of MFPs and all the MFPs searched in the network, first, only the usable MFPs are extracted, and for the extracted MFPs, server computer 200 may set whether each MFP is usable or not.

<Third Modification>

In the embodiment above, when the universal printer driver is installed, the client computer transmits the install information to the server computer. The present invention, however, is not limited to the above. It is unnecessary for the server computer to immediately set the limiting information for the client computer. By way of example, the limiting information for the client computer may be set by the server computer when printing is to be done, after the printer driver is installed in the client computer. Therefore, transmission of unnecessary information can be avoided until actual printing is to be done after the user installed the printer driver. Further, the timing when the server computer sets the limiting information for the client computer may not be at the time of printing, and it may set the information when the power of client computer is turned on after installation, or when the client computer is connected to the network. Further, in place of transmission of the install information, the server computer may detect downloading of a universal printer driver to the client computer. Determining that downloading is for installation, the server computer may operate the setting unit for setting the usable printing apparatuses, even when the install information is not transmitted from client computer. This realizes more speedy response and reduces unnecessary load of transmission.

<Fourth Modification>

In the embodiment described above, when a universal printer driver is installed, the install information is transmitted to the server computer and the server computer does not immediately set the use limiting information for the client computer. The present invention, however, is not limited to the above. Specifically, the use limiting information may be set immediately after the universal printer driver is installed in the client computer. This is advantageous, since it is unnecessary to transmit a print request to the server computer every time printing is to be done. Specifically, after S2080, the same contents are transmitted immediately to the client computer, and the contents are stored in the client computer. Thus, at the time of printing, printing can be done without making an inquiry to the server computer.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. A network print system in which a client computer, connected to a network together with a server computer and a plurality of printing apparatuses, prints an image using said printing apparatus, wherein
in response to installment of a universal printer driver is usable for various printing apparatuses, said client computer transmits install information to said server computer; and
based on received said install information, said server computer sets a printing apparatus or apparatuses usable by said client computer, among the printing apparatuses on said network.

2. A server computer used in a network print system in which a client computer, connected to a network together with the server computer and a plurality of printing apparatuses, prints an image using said printing apparatus, wherein in response to installment of a universal printer driver is usable for various printing apparatuses, said client computer transmits install information to said server computer;
said server computer comprising:
a detecting unit detecting said plurality of printing apparatuses; and
a setting unit setting, based on received said install information, a printing apparatus or apparatuses usable by said client computer, among the printing apparatuses on said network.

3. A computer readable recording medium recording a computer program causing, when executed by a computer including a communication unit, a storage unit and an operating unit, said computer to function as the server computer according to claim 2.

4. The server computer according to claim 2, wherein
said detecting unit detects said plurality of printing apparatuses by automatically searching through said network for the printing apparatuses connected to said network.

5. A computer readable recording medium recording a computer program causing, when executed by a computer including a communication unit, a storage unit and an operating unit, said computer to function as the server computer according to claim 4.

6. The server computer according to claim 2, further comprising
a storage unit for storing said detected printing apparatus with an IP address, host name, printing speed and color/black-and-white information.

7. A computer readable recording medium recording a computer program causing, when executed by a computer including a communication unit, a storage unit and an operating unit, said computer to function as the server computer according to claim 6.

8. The server computer according to claim 2, wherein
said setting unit sets a printing apparatus or apparatuses usable either by said client computer or a user logged in to said client computer.

9. A computer readable recording medium recording a computer program causing, when executed by a computer including a communication unit, a storage unit and an operating unit, said computer to function as the server computer according to claim 8.

10. The server computer according to claim 2, wherein
said setting unit sets a usable printing apparatus or apparatuses at the time of printing after said universal printer driver is installed in said client computer.

11. A computer readable recording medium recording a computer program causing, when executed by a computer including a communication unit, a storage unit and an operating unit, said computer to function as the server computer according to claim 10.

12. A computer readable recording medium recording a universal printer driver is usable for various printing apparatuses, when installed in a computer including a communication unit, a storage unit and an operating unit, causing, in said computer,
said universal printer driver to be stored in said storage unit to enable execution of a print request processing,
install information to be transmitted to said server computer, and
based on the information received from said server computer, image data to be transmitted to a printing apparatus of which use is permitted.

13. The recording medium according to claim 12, wherein
said computer further includes a display unit, and in said computer, based on the information received from said server computer, a printing apparatus or apparatuses of which use is permitted are displayed on said display unit.

14. The recording medium according to claim 13, wherein
based on the information received from said server computer, only a printing apparatus or apparatuses of which use is permitted are displayed on said display unit.
